(19) United States
(12) Patent Application Publication
(10) Pub. No.: US 2009/0143098 A1
(43) Pub. Date: Jun. 4, 2009

(54) ELECTRONIC EQUIPMENT

(75) Inventor: Mitsuji SHIONO, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/170,031

(22) Filed: Jul. 9, 2008

(30) Foreign Application Priority Data
Dec. 4, 2007 (JP) P2007-313609

(51) Int. Cl. H04M 1/00; H04B 1/38; H04N 5/445

(52) U.S. Cl. 455/556.1; 455/566; 348/552; 348/E05.099

(57) ABSTRACT

An electronic equipment includes a first output unit configured to output display information onto a display screen, a second output unit configured to output display information to a device to which the display information is output; and an output control unit configured to cause, if predetermined display information is output using both the first output unit and the second output unit, the second output unit to output the portion of the predetermined display information to which it is previously set that it is output to the outside as well as causing the first output unit to output the portion of the predetermined display information from which the portion output by the second output unit is excluded.

### BACKGROUND OF THE INVENTION

1. Field of the Invention

The present invention relates to electronic equipment having a plurality of output means of display information, and more particularly to electronic equipment capable of outputting individual display information to respective output means.

2. Description of the Related Art

Recently, since the functional property of mobile electronic equipment such as mobile phones and the like is improved, users use various functions such as Web browsing, a TV phone and the like using the mobile phones. When these functions are used using the mobile electronic equipment, although the mobile electronic equipment is advantageous in that it can be used anywhere at any time, the equipment has a problem in that it is difficult to observe the display thereof because it is a mobile type having a small size and the amount of information that can be displayed on the display is limited.

To cope with the above problem, there is proposed electronic equipment having a projector for projecting a screen to the outside (refer to Japanese Unexamined Patent Application Publication No. 2006-67469). The electronic equipment has a camera and a projector, and the production cost of the equipment is reduced by causing the camera and the projector to share the same lens optical system.

In particular, when a TV phone function of the mobile phone is used, since a picture received from an opponent side and a picture transmitted from a user side are ordinarily displayed on the same screen, these pictures are displayed in a small size, from which a problem arises in that it is difficult for the user to confirm the pictures.

To cope with the above problem, there is proposed a mobile TV phone which outputs image and audio to the outside when a call is made using the TV phone (refer to Japanese Unexamined Patent Application Publication No. 2006-121340). The mobile TV phone adjusts the characteristics of an mage signal and an audio signal to be output by analyzing an output image signal based on other image signal, which is created by picking up an image replayed by external equipment and on other audio signal created by receiving the audio which is replayed by the external equipment from an output audio signal.

Compact electronic equipment, which partly or entirely outputs display information to external equipment or partly or entirely projects it to the outside using a projector, is convenient because not only it can display information on a large display screen but also a plurality of persons can observe the display screen at the same time. However, even if the display information is displayed in enlargement, since the original size of the display information is the same as that displayed on a display of compact electronic equipment, the amount of information to be displayed cannot be increased and a clearer image cannot be displayed. Further, it is difficult for the user to observe a display on the display screen of the compact electronic equipment as ever.

An object of the present invention, which was made in view of the above problems, is to provide electronic equipment capable of clearly displaying a lot of information at a time.

### SUMMARY OF THE INVENTION

To solve the above problems, electronic equipment according to the present invention includes a first output unit configured to output display information on a display screen, a second output unit configured to output display information to a to-be-output body, and an output control unit configured to cause, if predetermined display information is output using both the first output unit and the second output unit, the second output unit to output the portion of the predetermined display information to which it is previously set that it is output to the outside as well as causing the first output unit to output the portion of the predetermined display information from which the portion output by the second output unit is excluded.

According to the electronic equipment of the present invention, it is possible to clearly display a lot of information at a time by causing a plurality of output unit to output display information individually.

### BRIEF DESCRIPTION OF THE DRAWINGS

FIG. 1 is a perspective view showing an open state of electronic equipment (mobile phone) according to the present invention;

FIG. 2 is a view explaining an internal structure of a projector of the electronic equipment (mobile phone) according to the present invention;

FIG. 3 is a function block diagram of the electronic equipment (mobile phone) according to the present invention;

FIG. 4 is a data formation view showing telephone directory information;

FIG. 5 is a flowchart showing a procedure when telephone directory display processing is performed in the electronic equipment (mobile phone) according to the present invention;

FIG. 6A is a screen view showing an example of a display screen displayed on a liquid crystal display at the time the projector is used when the telephone directory display processing is performed in the electronic equipment (mobile phone) according to the present invention;

FIG. 6B is a screen view showing an example of a projection screen projected onto the projection surface of the projector at the time the projector is used when the telephone directory display processing is performed in the electronic equipment (mobile phone) according to the present invention;

FIG. 6C is a screen view showing an example of the display screen displayed on the liquid crystal display at the time the projector is used when the telephone directory display processing is performed in the electronic equipment (mobile phone) according to the present invention;

FIG. 7 is a screen view showing an example of the display screen displayed on the liquid crystal display at the time the projector is not used when the telephone directory display processing is performed in the electronic equipment (mobile phone) according to the present invention;

FIG. 8 is a flowchart showing a procedure when Web page display processing is performed in the electronic equipment (mobile phone) according to the present invention;

FIG. 9A is a screen view showing an example of the display screen displayed on the liquid crystal display when the Web page display processing is performed in the electronic equipment (mobile phone) according to the present invention;

FIG. 9B is a screen view showing an example of the projection screen displayed on the project surface of the projector when the Web page display processing is performed in the electronic equipment (mobile phone) according to the present invention;

FIG. 9C is an example of the display screen displayed on the liquid crystal display at the time a character input is instructed when the Web page display processing is performed in the electronic equipment (mobile phone) according to the present invention;

FIG. 9D is a screen view showing an example of the projection screen displayed on the project surface of the projector at the time the character input is instructed when the Web page display processing is performed in the electronic equipment (mobile phone) according to the present invention;

FIG. 10 is a flowchart showing a procedure when mail reception processing is performed while a display is made by the projector in the electronic equipment (mobile phone) according to the present invention;

FIG. 11A is a screen view showing an example of the display screen displayed on the liquid crystal display when the mail reception processing is performed while a display is made by the projector in the electronic equipment (mobile phone) according to the present invention;

FIG. 11B is a screen view showing an example of the projecting screen displayed on the project surface of the projector when the mail reception processing is performed while a display is made by the projector in the electronic equipment (mobile phone) according to the present invention;

FIG. 11C is a screen view showing an example of the display screen displayed on the liquid crystal display at the time a mail is received when the mail reception processing is performed while a display is made by the projector in the electronic equipment (mobile phone) according to the present invention;

FIG. 11D is a screen view showing an example of the projection screen displayed on the project surface of the projector at the time a mail is received when the mail reception processing is performed while a display is made by the projector in the electronic equipment (mobile phone) according to the present invention;

FIG. 11E is a screen view showing an example of the display screen displayed on the liquid crystal display at the time mails are browsed when the mail reception processing is performed while a display is made by the projector in the electronic equipment (mobile phone) according to the present invention;

FIG. 11F is a screen view showing an example of the projection screen displayed on the project surface of the projector at the time mails are browsed when the mail reception processing is performed while a display is made by the projector in the electronic equipment (mobile phone) according to the present invention;

FIG. 12 is a flowchart showing a procedure when incoming call processing is performed while a display is made by the projector in the electronic equipment (mobile phone) according to the present invention;

FIG. 13A is a screen view showing an example of the display screen displayed on the liquid crystal display when incoming call processing is performed while a display is made by the projector in the electronic equipment (mobile phone) according to the present invention;

FIG. 13B is a screen view showing an example of the projection screen displayed on the project surface of the projector when incoming call processing is performed while a display is made by the projector in the electronic equipment (mobile phone) according to the present invention;

FIG. 13C is a screen view showing an example of the display screen displayed on the liquid crystal display when incoming call processing is performed while a display is made by the projector in the electronic equipment (mobile phone) according to the present invention;

FIG. 13D is a screen view showing an example of the projection screen displayed on the project surface of the projector when incoming call processing is performed while a display is made by the projector in the electronic equipment (mobile phone) according to the present invention;

FIG. 14 is a data formation view showing display destination information;

FIG. 15 is a flowchart showing a procedure when TV phone processing is performed in the electronic equipment (mobile phone) according to the present invention;

16A is a screen view showing an example of the display screen displayed on the liquid crystal display when TV phone processing Is performed in the electronic equipment (mobile phone) according to the present invention;

FIG. 16B is a screen view showing an example of the projection screen displayed on the project surface of the projector when the TV phone processing is performed in the electronic equipment (mobile phone) according to the present invention;

FIG. 17A is a screen view showing an example of the display screen displayed on the liquid crystal display when the TV phone processing is performed in the electronic equipment (mobile phone) according to the present invention;

FIG. 17B is a screen view showing an example of the projection screen displayed on the project surface of the projector when the TV phone processing is performed in the electronic equipment (mobile phone) according to the present invention.

### DESCRIPTION OF THE PREFERRED EMBODIMENT

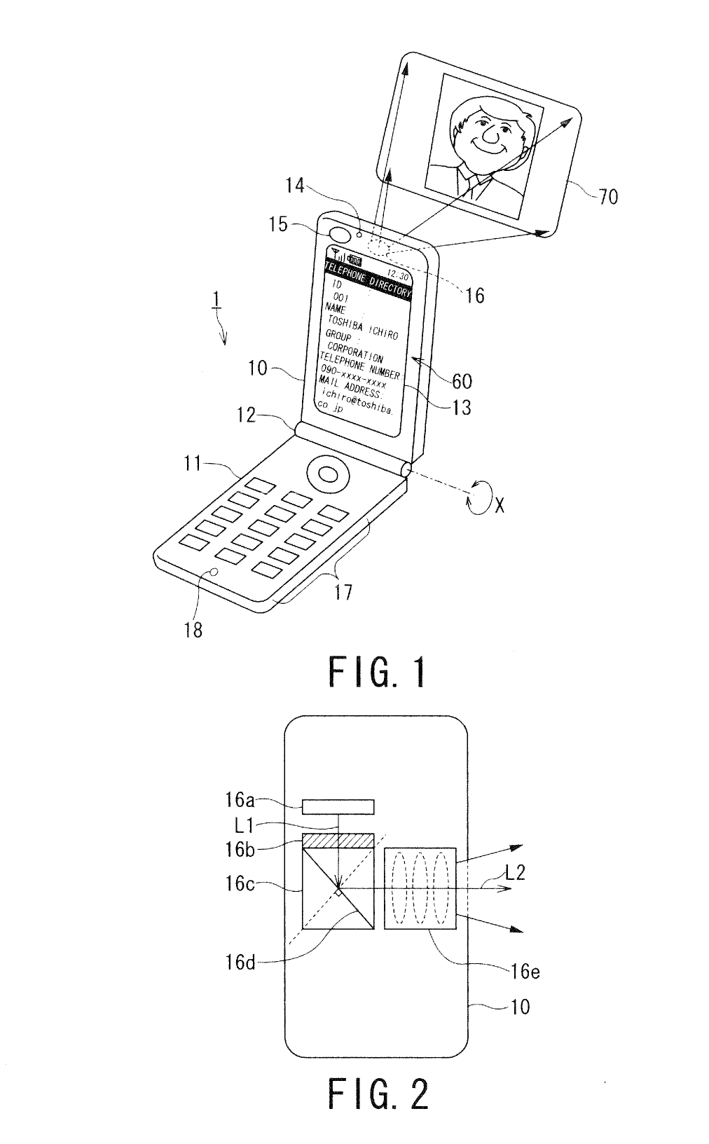

An embodiment of electronic equipment according to the present invention will be explained referring to accompanying drawings. A clamshell type mobile phone, which is composed of a plurality of bodies openably/closably coupled with each other, will be explained as an example of the electronic equipment according to the present invention. FIG. 1 is a perspective view showing an open state of a mobile phone 1.

As shown in FIG. 1, the mobile phone is mainly composed of a rectangular plate-shaped upper body 10 and a lower body 11 which has approximately the same shape as the upper body 10, and the upper body 10 is overlapped on the lower body 11 so as to cover one surface in a closed state The upper body 10 is hinge-coupled with the lower body 11 across a hinge portion 12, and the upper body 10 is formed to turn about the hinge portion 12 a predetermined angle in an X-direction of FIG. 1. The mobile phone 1 is changed from a closed state to an open state or from the open state to the closed state when the upper body 10 is turned with respect to the lower body 11.

A liquid crystal display 13 for displaying a display screen 60 including information such as characters, images, and the like, a speaker 14 for outputting voice, a CCD camera 15 for picking up surrounding landscapes are disposed to the inside surface (surface that confronts the lower body 11) of the upper body 10. The liquid crystal display 13, the speaker 14, and the CCD camera 15 are covered with the lower body 11 when the mobile phone 1 is in the closed state and are not exposed to the outside. However, when the upper body 10 is turned with respect to the lower body 11 and the mobile phone 1 becomes being in an open state, they are exposed to the outside.

A projector 16 is disposed on the outside surface of the upper body 10 (surface that does not confront the lower body 11) to project a projection screen 70 including information such as characters, images, and the like onto a wall and the like in the vicinity thereof. Display information is projected from the projector 16 to the outside surface side of the upper body 10. In the upper body 10, the CCD camera 15 is disposed to face the back side of the projector 16. Accordingly, when the mobile phone 1 is opened so that the upper body 10 is approximately at right angles to the lower body 11, that is, so that the lower body 11 is disposed in a horizontal direction and the upper body 10 is disposed in a vertical direction, a user can use the projector 16 while picking up an image on his or her side by the CCD camera 15 when the mobile phone 1 is used as a TV phone or can use the projector 16 while the operator performs a Web browsing operation.

Operation keys 17, for example, a cross key for moving a cursor and a display screen up, down, right, and left, a selection key for selecting an item, numeral keys for inputting numerals, a transmission key for performing transmission processing, and the like are disposed on the inside surface (the surface that confronts the upper body 10) of the lower body 11.

Further, a microphone 18 for collecting voice is disposed to the lower body 11. Although the operation keys 17 and the microphone 18 are covered with the upper body 10 and are not exposed to the outside when the mobile phone 1 is in the closed state, when the mobile phone 1 becomes being in the open state, they are exposed to the outside.

FIG. 2 is an explanatory view showing an internal arrangement of the projector 16 when the upper body 10 is viewed from the vertical direction. As shown in FIG. 2, the projector 16 has an LED 16a which emits the light to be projected from the mobile phone 1 as projecting light. The light emitted from the LED 16a is modulated in a liquid crystal panel 16b, passes through a first light path L1, and is reflected on a reflection surface 16d of a light reflection member 16c. The reflection surface 16d is disposed in the light reflection member 16c at the position where the projecting light from the first light path L1 is guided to the outside passing through a second light path L2. A projected image is guided to a projection surface by, for example, disposing the first light path L1 at right angles to the second light path L2, and disposing the reflection surface 16d at 45 degrees to the first and second light paths L1 and L2.

After the projecting light reflected on the reflection surface 16d of the light reflection member 16c passes through the second light path L2, it is incidents on a lens optical system 16e and outgoes to the outside of the mobile phone 1 after it is enlarged or reduced by the lens optical system 16e. The lens optical system 16e has a drive mechanism for changing the positions of a plurality of lenses so that it is provided with a zoom function. The projecting light, which outgoes from the mobile phone 1 while being enlarged or reduced by the lens optical system 16e, is projected onto the projection surface of the wall and the like in the vicinity thereof as the projection screen 70.

Note that the light reflection member 16c may be omitted from the projector 16 so that the projecting light modulated in a liquid crystal panel 17b is directly incident on the lens optical system 17e without being reflected on the light reflection member 17c.

As described above, the mobile phone 1 includes the projector 16 for outputting display contents to the outside in addition to the liquid crystal display 13 as a display means. As s result, it is possible to partly or entirely display the display screen 60 of the liquid crystal display 13 on the projection screen 70 of the projector 16 at the same time and to display the display contents different from those of the liquid crystal display 13 on the projection screen 70 of the projector 16 at the same time.

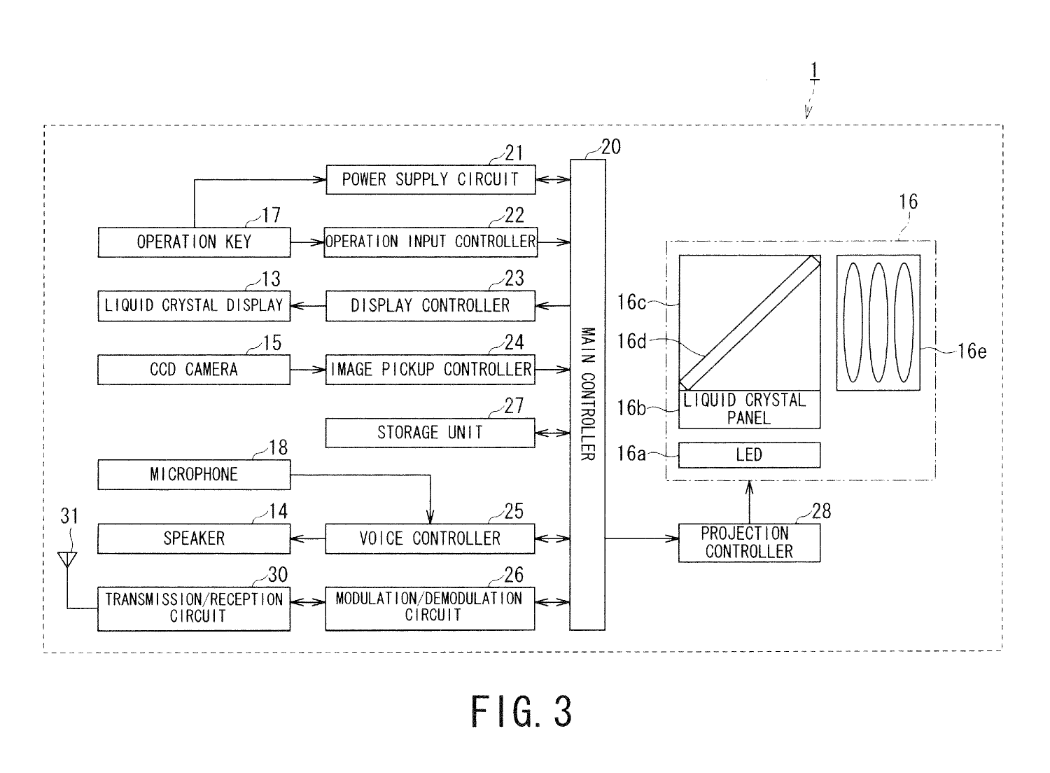

Next, a function of the mobile phone 1 will be explained using a function block diagram shown in FIG. 3. As shown in FIG. 3, the mobile phone 1 is composed of a main controller 20, a power supply circuit 21, an operation input controller 22, a display controller 23, an image pickup controller 24, a voice controller 25, a modulation/demodulation circuit 26, a storage unit 27, and a project controller 28 which are connected to each other through a bus.

The main controller 20 has a CPU (Central Processing Unit) and integrally controls the mobile phone 1 as well as performs various other arithmetic processing, control processing, and the like. The power supply circuit 21 switches the ON/OFF state of a power supply based on an input from the user through the operation keys 17. When the power supply is turned ON, power is supplied from a power supply source (battery and the like) to the respective units so that the mobile phone 1 can be operated.

The operation input controller 22 has an input interface for the operation keys 17 and transmits a signal input through the operation keys 17 to the main controller 20. The display controller 23 has a display interface for the liquid crystal display 13 and displays display information including a document, an image, and the like on the liquid crystal display 13 as the display screen 60 under the control of the main controller 20. The image pickup controller 24 obtains the image data picked up by the CCD camera 15, encodes the image data in a predetermined format such as MPEG (Moving Picture Experts Group)-4 and the like, and transmits it to the main controller 20.

The mobile phone 1 performs voice communication processing to other mobile phone and fixed-line phone through a base station (not shown). That is, the voice controller 25 obtains the voice collected by the microphone 18 under the control of the main controller 20, converts the analog signal of the voice to a digital signal, and transmits it to the modulation/demodulation circuit 26. The modulation/demodulation circuit 26 subjects the digital signal to spectrum diffusion processing and transmits it to a transmission/reception circuit 30. The transmission/reception circuit 30 transmits the digital signal to the base station through an antenna 31.

Further, the modulation/demodulation circuit 26 subjects the digital signal, which is received by the transmission/reception circuit 30 from the base station through the antenna 31, to spectrum reverse diffusion processing and transmits it to the voice controller 25. When a voice communication is performed, the voice controller 25 converts the digital signal obtained from the modulation/demodulation circuit 26 to an analog signal and the voice is output from the speaker 14.

Further, the mobile phone 1 performs data communication processing to other mobile phone and communication equipment. That is, the mobile phone 1 transmits and receives various data such as electronic mails, Web browsing data, TV phone image data, and the like. When the data is received, the main controller 20 subjects the reception signal, which is received by the transmission/reception circuit 30 from the base station through the antenna 31, to the spectrum reverse diffusion processing in the modulation/demodulation circuit 26 and restores the data. The data is displayed on the liquid crystal display 13 through the display controller 23 or recorded to the storage unit 27 in response to an instruction from the main controller 20.

Further, when the main controller 20 transmits the data input through an operation input unit 22 and the data stored in the storage unit 27, the modulation/demodulation circuit 26 subjects the data to the spectrum diffusion processing, and the transmission/reception circuit 30 transmits it to the base station through the antenna 31.

The storage unit 27 is composed of a ROM (Read Only Memory), a hard disc, and a non-volatile memory, which store a processing program used when the main controller 20 performs processing, data necessary to the processing, and the like, a RAM (Random Access Memory) for temporarily storing the data used when the main controller 20 performs the processing, and the like. It is assumed that a processing program, which is used when the main controller 20 performs telephone directory display processing and the like to be described later, is stored to, for example, the ROM. It is assumed that the display information, which is displayed on the liquid crystal display 13 when a display is performed by the projector 16, and the display information of the projection screen 70, which is projected by the projector 16, are also stored in the storage unit 27. Further, it is assumed that setting information, which shows whether or not the respective processing are displayed by the projector (output to the outside) when they are performed, is also stored in the storage unit 27.

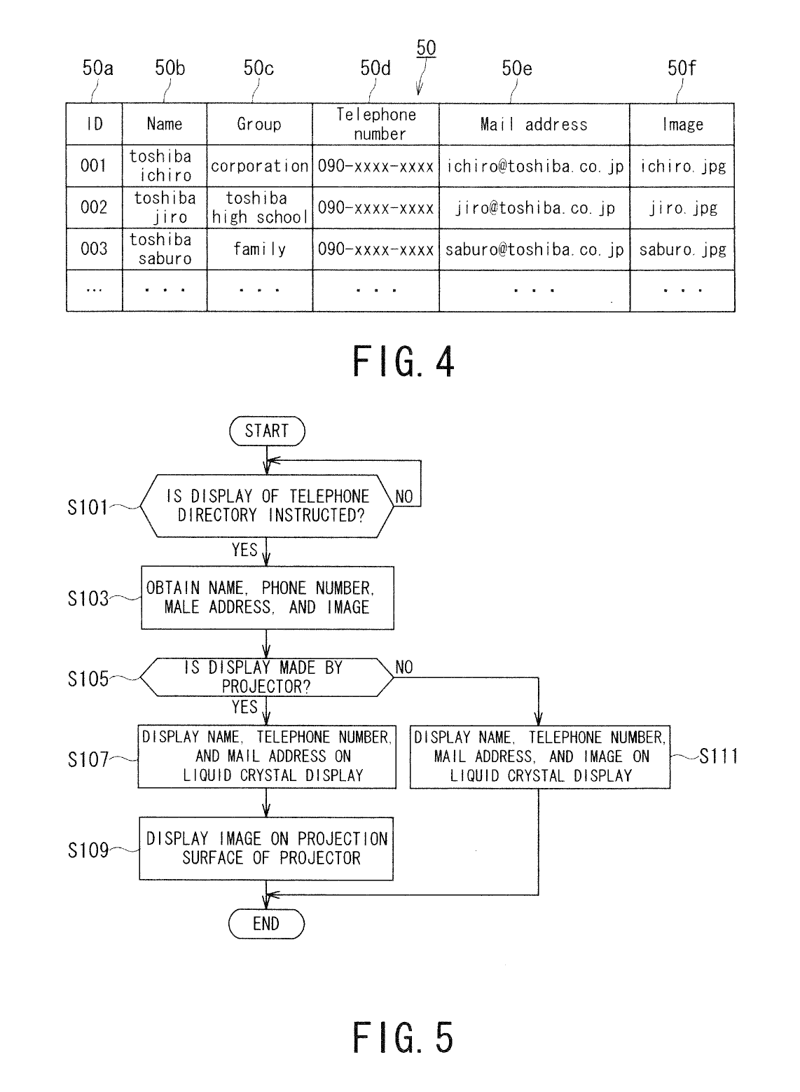

Further, the storage unit 27 stores telephone directory information 50 which is used when a phone call is performed or when a mail is transmitted and received. As shown in FIG. 4, the telephone directory information 50 is the information in which at least name information 50b showing the names of the user's acquaintances, group information 50c showing the groups to which the user's acquaintances belong, phone number information 50d showing the phone numbers of the user's acquaintances, mail address information 50e showing the mail addresses of the user's acquaintances, and image information 50f showing images of the user's acquaintances are caused to correspond to ID information 50a as identification information, respectively. The image information 50f is shown by, for example, the file name or the path of an image file.

Whether or not the respective information of the telephone directory information 50 are to be displayed by the projector 16 (to be output to the outside) is previously set, and when the telephone directory information 50 is displayed, only the information, which is set so that it is displayed by the projector 16 is projected onto the projection screen 70 of the projector 16. It is assumed here that, for example, only the image information 50f is set so that it is displayed by the projector and the information of the name information 50b and the like other than the image information 50f is set so that it is not displayed by the projector.

In, for example, the telephone directory Information 50 shown in FIG. 4, the name information 50b of “TOSHIBA Ichirou”, the group information 50c of “corporation”, the phone number information 50d of “090-xxxx-xxxx”, the mail address information 50e of “ichiro@toshiba.co.jp”, and the image information 50f of “ichiro.jpg” are caused to correspond to the ID information 50a of “001”, respectively.

The project controller 28 has an output interface for the projector 16 and instructs the projector 16 to project the display information including a document, an image and the like based on an instruction from the main controller 20, and the project or 16 projects the display information on the projection surface of the wall and the like in the vicinity thereof as the projection screen 70 based on the instruction.

### EXAMPLE 1

When the mobile phone 1 displays the telephone directory information 50, the telephone directory information 50 includes also image information in addition to a lot of character informations. Thus, when it is intended to display all the information on the display screen 60 of the liquid crystal display 13, it is necessary to display characters and images on the display screen 60 by reducing the size thereof and to display the information which cannot be displayed on the screen by scrolling it.

To cope with this problem, the mobile phone 1 displays a part of the telephone directory information 50 on the projection screen 70 of the projector 16 and displays the remaining information on the display screen 60 of the liquid crystal display 13 as necessary. The telephone directory display processing will be explained as an example 1 of the mobile phone 1 based on FIGS. 5 to 7.

A procedure when the main controller 20 of the mobile phone 1 performs the telephone directory display processing will be explained based on a flowchart shown in FIG. 5. In the following explanation, a step, for example, “step S101” is shown as “S101” omitting the term “step”.

First, the main controller 20 determines whether or not the user instructs to display a telephone directory (S101). At the time, the user instructs to display the telephone directory by an input through the operation keys 17, and the like. When It is not instructed to display the telephone directory (S101: No), the main controller 20 waits as it is. When it is instructed to display the telephone directory (S101: Yes), the main controller 20 obtains the telephone directory information 50 including at least the name information 50b, the phone number information 50d, the mail address information 50e, the image information 50f, and the like from the storage unit 27 (S103).

The main controller 20 determines whether or not it is set that the telephone directory information 50 is displayed (output through the projector 16 when the telephone directory information 50 is displayed (S105). The determination is performed based on, for example, the setting information showing whether or not the telephone directory information 50 is displayed through the projector 16. The setting information is, for example, previously input by the user and stored to the storage unit 27. Otherwise, the user may input whether or not the telephone directory is displayed through the projector 16 by an input through the operation keys 17 each time it is displayed.

When it is set that the telephone directory is displayed through the projector 16 (S105: Yes), the main controller 20 displays the information, which is set such that it is not displayed through the projector 16, in the telephone directory information 50 obtained at step S103, that is, the display information including the information (information other than the image information 50f) such as the name information 50b, the telephone directory information 50d, the mail address information 50e and the like on the liquid crystal display 13 as the display screen 60 (S107). At the time, the display 13 can display a larger amount information by the amount of the image information 50f displayed only through the projector 16.

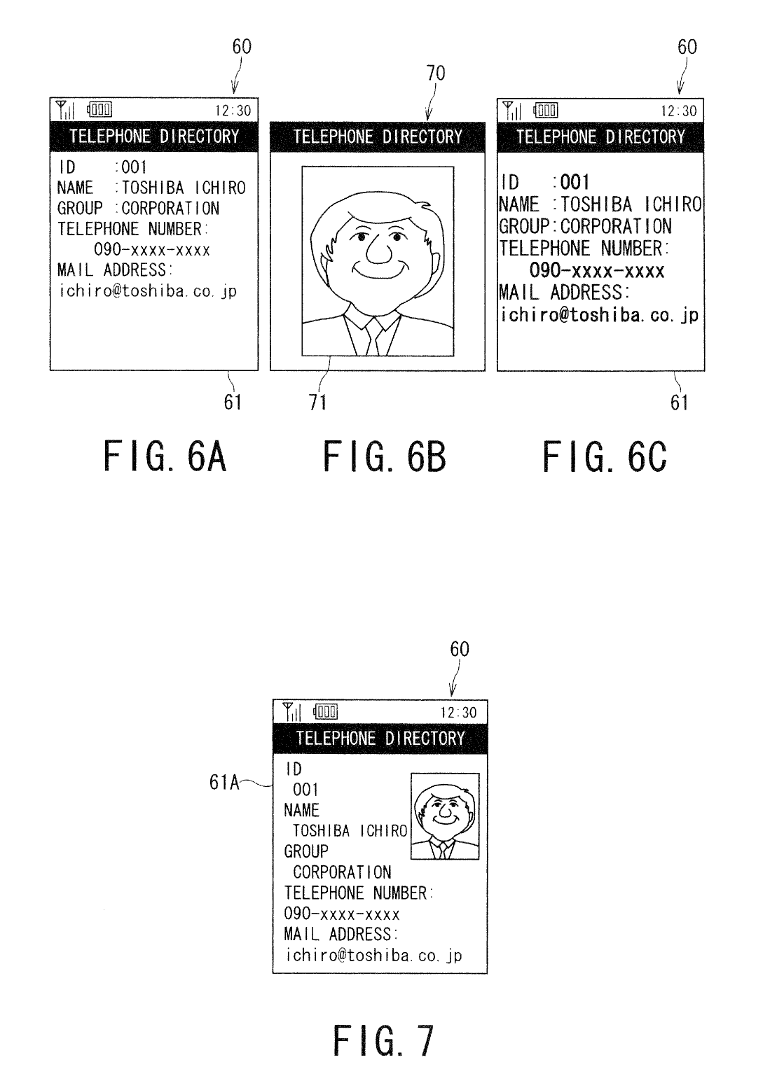

The display screen 60 at the time includes a display column 61, on which “001” stored as ID information 50a, the name information 50b “TOSHIBA Ichiro”which is caused to correspond to the ID information 50a, the group information 50c “corporation”, the phone number information 50d “090-xxxx-xxxx”, and the mail address information 50e “ichiro@toshiba.co.jp”are displayed, in the telephone directory information 50 as shown in, for example, FIG. 6A.

The main controller 20 displays the information, which is set such that it is displayed through the projector, in the telephone directory information 50 obtained at step S103, that is, the display information including only the image information 50f through the projector 16 as the projection screen 70 (S109). At the time, since only the limited information in the telephone directory information 50 is projected onto the projection screen 70, it is possible to make a clear display on the projection screen 70. The projection screen 70 at the time includes a display column 71, in which the image of the image information 50f “ichiro.jpg” that is caused to correspond to the ID information 50a “001” is shown in the telephone directory information 50, as shown in, for example, FIG. 6B.

When it is set that the display through the projector is not performed (S105: No), the main controller 20 displays the display information, which includes the telephone directory information 50 obtained at S103, on the liquid crystal display 13 as the display screen 60 (S111). The display screen 60 at the time includes a display column 61A, on which “001” stored as ID information 50a, the name information 50b “TOSHIBA Ichiro” which is caused to correspond to the ID information 50a, the group information 50c “corporation”, the phone number information 50d “090-xxxx-xxxx”, the mail address information 50e “ichiro@toshiba.co.jp” are displayed, and the image information 50f “ichiro.jpg” in the telephone directory information 50 as shown in, for example, FIG. 7.

When the mobile phone 1 displays the telephone directory information 50 using the projector 16 as described above, only the image information 50f, to which it is set that the image information 50f is displayed through the projector, in the telephone directory 50, is displayed on the projection screen of the projector 16, and the information (the name information 50b and the like) other than the image information 50f is displayed on the liquid crystal display 13. Further, when the mobile phone 1 displays the telephone directory information 50 without using the projector 16, it displays all the information of the telephone directory information 50 on the liquid crystal display 13.

When a part of the contents displayed on the display screen 60 of the liquid crystal display 13 is simply extracted and projected onto the projection screen 70 of the projector 16 or when all the displayed contents are projected onto the projection screen 70 of the projector 16, there is a possibility that they are displayed indistinctly and further the display on the display screen 60 does not become easy to observe because even if the display contents are enlarged on the projection screen 70, the size of the display contents does not change from the size to be originally displayed on the liquid crystal display 13. In the mobile phone 1 of the present invention, since display contents, which are displayed on the display screen 60 of displayed on the liquid crystal display 13, are created separately from and the display contents which are projected onto the projection screen 70 of the protector 16, it is possible to clearly display a lot of information at a time.

Note that the example, in which only the image information 50f, to which it is set that the image information 50f is displayed through the projector 16, in the telephone directory 50 is displayed on the projection screen 70 through the projector 16 and the information other than the image information 50f is displayed on the display screen 60 of the liquid crystal display 13, is explained as the example 1. However, the present invention is not limited thereto, and the information displayed on the display screen 60 and the information projected onto the projection screen 70 may be selected by any arbitrary method.

Further, although the example that the telephone directory information 50 is displayed is explained as the example 1, the present invention is not limited thereto and can be applied to display arbitrary information such as mail information and the like, and further it can be applied when a Web page is displayed, when a screen for executing an application program is displayed, and the like.

Further, it is preferable to display the information, which is not displayed through the projector 16, on the display screen 60 in enlargement by, for example, increasing the size of characters or thickening the characters as shown in FIG. 6C. That is, since an additional display space can be obtained by not displaying the image information 50f as compared with the display screen 60 shown in FIG. 7, it is preferable to display the display information by enlarging it as large as the size of the display screen 60 as shown in FIG. 6C. With this arrangement, the display space of the display screen 60 of the liquid crystal display 13 can be effective utilized as well as a display which can be more easily observed by the user can be made.

According to the example 1 of the electronic equipment (the mobile phone 1) of the present invention, when the telephone directory information 50 is displayed, it is possible to clearly display a lot of the telephone directory information 50 at a time by displaying a part of the display information (the image information 50f) on the projection screen 70 of the projector 16 and displaying the remaining display information (the telephone directory information 50 other than the image information 50f) on the display screen 60 of the liquid crystal display 13.

### EXAMPLE 2

There is considered a case in which when the user browses a Web page using the mobile phone 1, he or she performs various input operations to the Web page to input a Web page URL and a search character string, to input data to a message board, and the like. There is also considered circumstances in which when a Web page is projected onto the projection screen 70 of the projector 16 and a plurality of persons browse the Web page, the information as to the input processing should not be projected onto the projection screen 70.

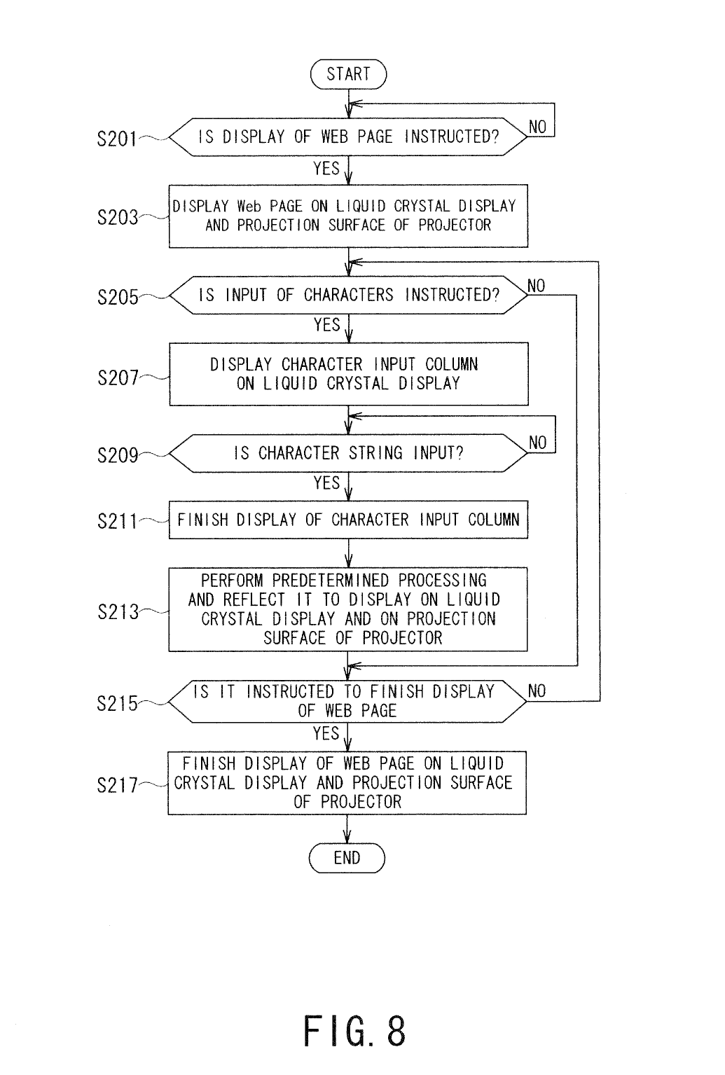

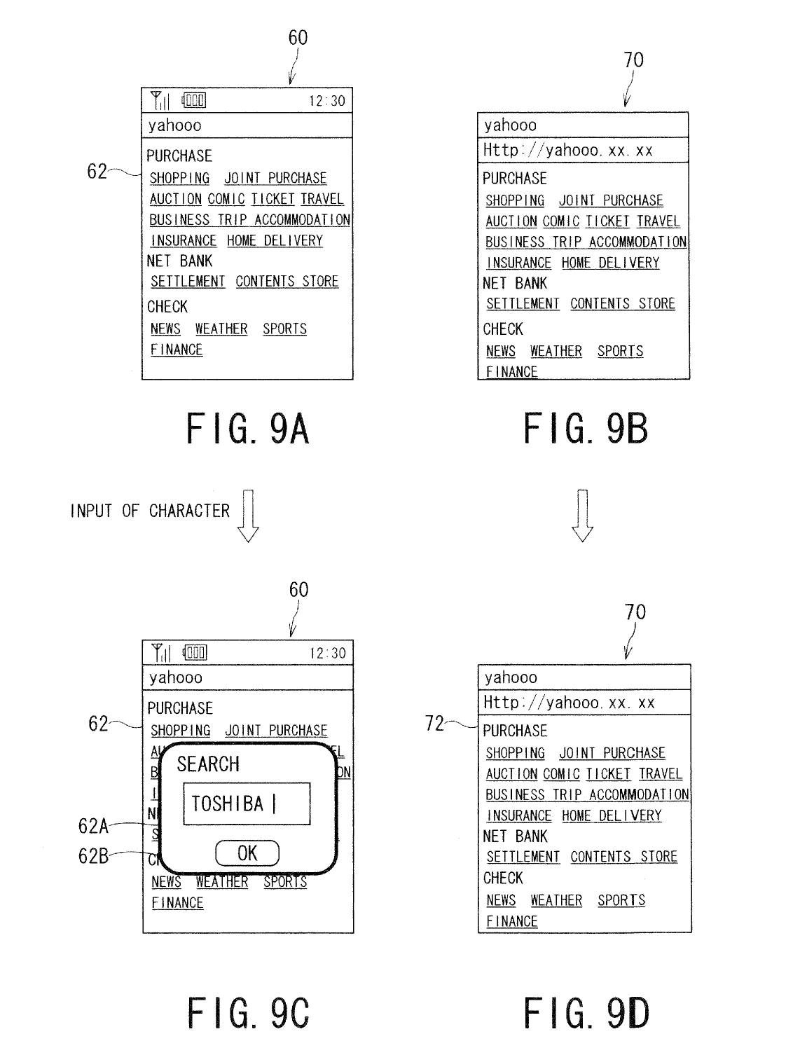

Thus, when the user inputs data to the Web page while the Web page is being displayed on the projection screen 70 of the projector 16, the mobile phone 1 displays the information as to the input processing only on the display screen 60 of the liquid crystal display 13. The Web page display processing will be explained as the example 2 of the mobile phone 1 based on FIGS. 8 and 9.

A procedure when the mobile phone 1 performs the Web page display processing will be explained based on a flowchart shown in FIG. 8. Note that it is assumed in the example 2 that when the user instructs to display a Web page on the projection screen 70 of the projector 16, the mobile phone 1 displays the Web page on the projection screen 70 of the projector 16 as well as displays the same information as that displayed on the projection screen 70 on the liquid crystal display 13.

First, the main controller 20 determines whether or not the user instructs to display the Web page (S201). At the time, the user instructs to display the Web page by an input through the operation keys 17, and the like. When the user does not instruct to display the Web page (S201: No), the main controller 20 waits as it is.

When it is instructed to display the Web page (S201: Yes), the main controller 20 obtains Web browsing note information and creates a Web page and displays the Web page on the liquid crystal display 13 as the display screen 60 as well as displays it on the projection screen of the projector 16 as the projection screen 70 (S203). When the Web page is created, the Web browsing information stored in the storage unit 27 may be obtained or Web browsing information may be obtained through the antenna 31. The display screen 60 at the time includes a Web page display column 62 in which the contents of the Web page are displayed as shown in FIG. 9A. Further, the projection screen 70 at the time also includes a Web page display column 72 in which the contents of the Web page are displayed likewise as shown in FIG. 9B.

The main controller 20 determines whether or not the user instructs to input characters to the Web page being displayed (S205). When, for example, the user designates URL while the Web page is being browsed, when the user inputs a search character string, when the user writes in a message board, and the like, the user instructs to input characters by an input through the operation keys 17, and the like.

When the user instructs to input the characters (S205: Yes), the main controller 20 displays a character input column 62A for inputting a character string on the display screen 60 of the liquid crystal display 13 (S207). At the time, a character input column 62A and an OK button 62B, which fixes the character string input to the character input column 62A, is displayed overlapping on the Web, page display column 62 displayed at step S203 as shown in FIG. 9C. At the time, the information as to input processing such as a character string input screen, the OK button, and the like is not displayed on the projection screen 70, and the state displayed at step S203 is held as shown in FIG. 9D.

When the character input column 62 is displayed on the display screen 60, the user inputs the character string through the operation keys 17 and selects the OK button 62B when the input is finished. The main controller 20 determines whether or not the character string is input depending on whether or not the OK button 62B is selected (S209). When the character string is not input (S209: No), the main controller 20 waits until the character string is input.

When the character string is input (S209: Yes), the main controller 20 finishes the displays of the character input column 62A and the OK button 62B on the display screen 60 of the liquid crystal display 13 and restores the display state at step S203 (S211). The main controller 20 performs predetermined processing based on the character string input at step S209 as well as reflects the processing to the display on the display screen 60 of the liquid crystal display 13 and to the display by the projector 16 on the projection screen 70 of the projector 16 (S213). When, for example, a transition destination URL is input at step S209, the main controller 20 obtains and displays the Web browsing information corresponding to the URL, and when a search character string is input, the main controller 20 obtains a result of search from a predetermined server based on the search character string and displays it.

When the processing at step S213 is finished, or when it is not instructed to input the characters (S205: No), the main controller 20 determines whether or not it is instructed to finish the display of the Web page (S215). The user instructs to finish the display of the Web page by, for example, an input through the operation keys 17, and the like. When it is not instructed to finish the display of the Web page (S215: No), the main controller 20 returns to step S205 at which it is determined whether or not it is instructed to input characters again.

When it is instructed to finish the display of the Web page (S215: Yes), the main controller 20 finishes the display of the Web page on the display screen 60 of the liquid crystal display 13 and the display of the Web page on the projection screen 70 of the projector 16 (S217).

When the Web page is browsed in the mobile phone 1 as described above, the Web page is displayed on both the display screen 60 of the liquid crystal display 13 and the projection screen 70 of the projector 16 as well as when the user instructs to input characters, the character input the column is displayed only on the display screen 60 of the liquid crystal display 13.

Note that although the example in which the user inputs the character string to the Web page is explained as the example 2, the present invention is not limited thereto and can be also applied when the image information stored in the storage unit 17 is selected, when the setting of a Web browser is changed, and the like.

According to the example 2 of the electronic equipment (the mobile phone 1) of present invention, when the Web page is displayed, it is displayed on the projection screen 70 of the projector 16 and on the display screen 60 of the liquid crystal display 13, and when the user performs an input operation, the information as to the input processing is displayed on the display screen 60 of the liquid crystal display 13. As a result, it is possible to clearly display a lot of information at a time.

### EXAMPLE 3

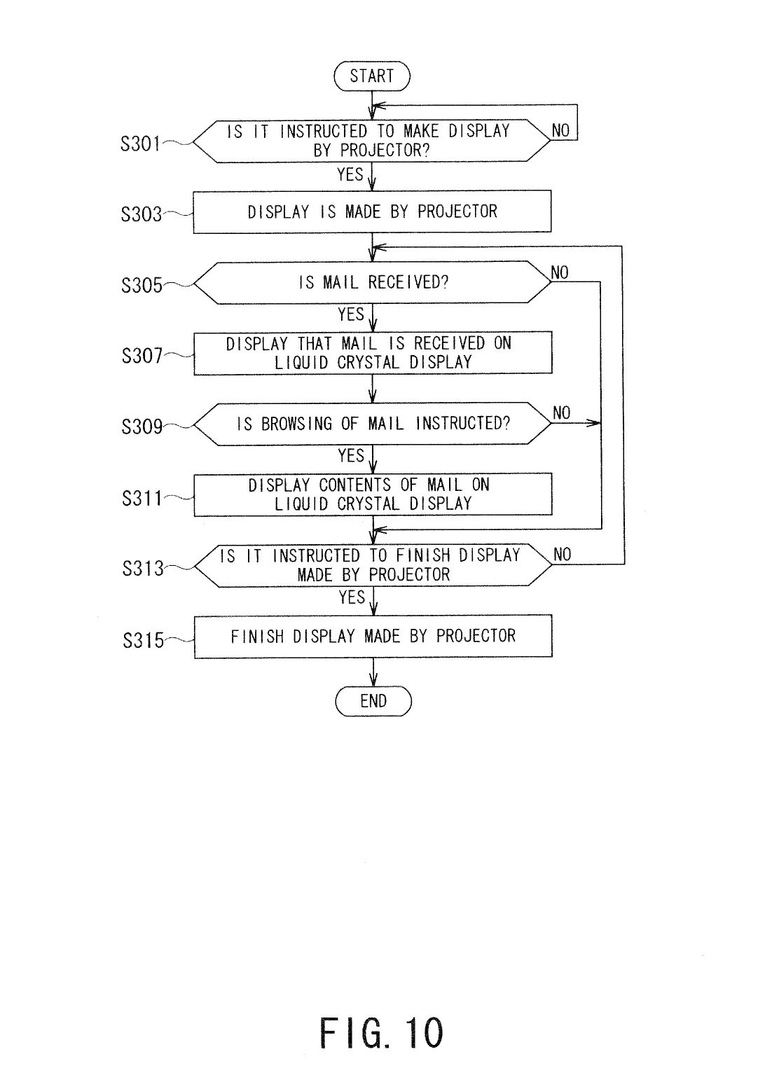

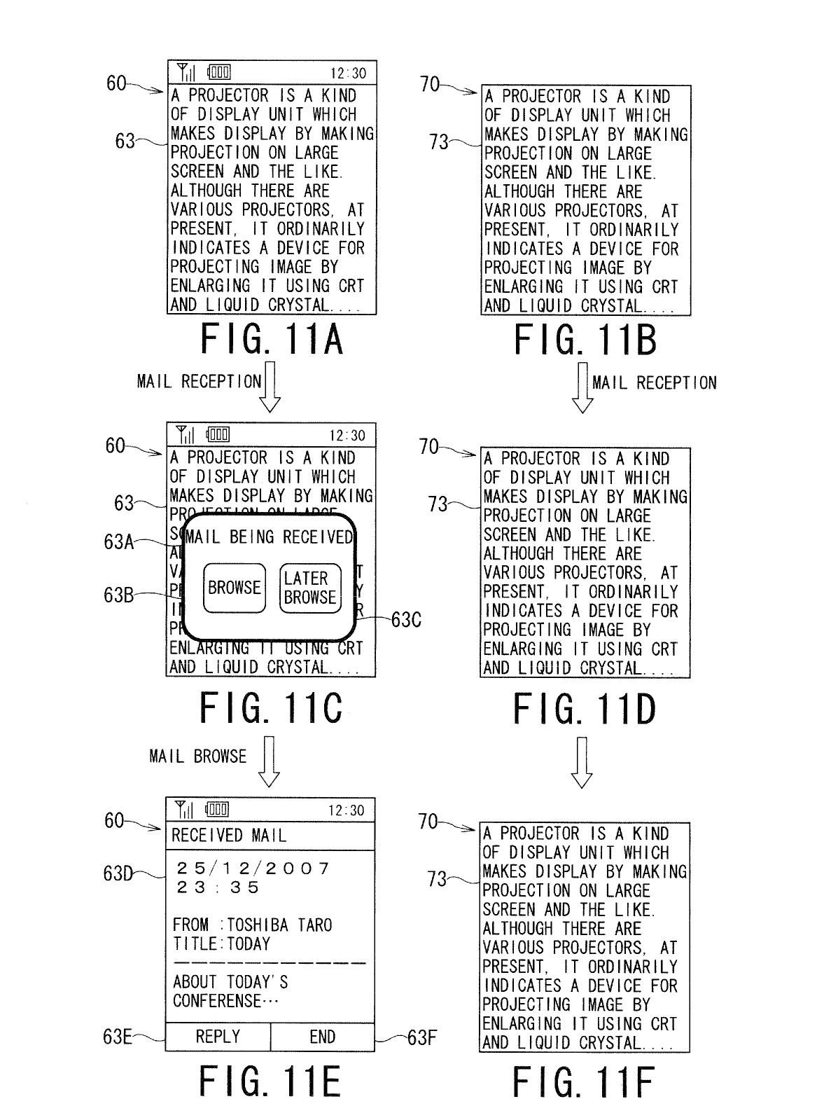

The user can hold a conference together with a plurality of persons while confirming the projection screen 70 of the projector 16, on which information for explanation is projected, by all of them making use of the display of the mobile phone 1 through the projector 16. However, when the mobile phone 1 receives a mail while the plurality of persons observe the projection screen 70, there are contemplated circumstances in which although the user of the mobile phone 1 must confirm the information of the mail, the user does not want the other persons who observe the projection screen 70 to read the information of the mail. A mail receiving procedure while a display being performed by the projector 16 will be explained as an embodiment 3 of the mobile phone 1 based on FIGS. 10 and 11.

A procedure when the mobile phone 1 performs the mail receiving procedure while the display being performed by the projector 16 will be explained based on a flowchart shown in FIG. 10. Note that it is assumed that when the user instructs to make a display by the projector 16, the mobile phone 1 displays predetermined display information on the display screen 60 of the liquid crystal display 13 and on the projection screen 70 of the projector 16.

First, the main controller 20 determines whether or not the user instructs to make the display by the projector 16 (S301). At the time, the user instructs to make the display by the projector by an input through the operation keys 17, and the like. When it is not instructed to make the display by the projector 16 (S301: No), the main controller 20 waits as it is.

When it is instructed to make the display by the projector 16 (S301: Yes), the main controller 20 obtains predetermined display information, displays the display information on the liquid crystal display 13 as the display screen 60 as well as displays it on the projection screen of the projector 16 as the projection screen 70 (S303). At the time, the display information stored in the storage unit 27 may be obtained or display information may be obtained through the antenna 31. The display screen 60 at the time includes a display information display column 63 on which the display information is displayed as shown in FIG. 11A. Further, the projection screen 70 at the time also includes a display information display column 73 on which the display information is displayed likewise as shown in FIG. 11B.

The main controller 20 determines whether or not a mail is received (S305). When the mall is received (S305: Yes), the main controller 20 displays a received mail display column 63A on the display screen 60 of the liquid crystal display 13 to display that the mail is received. (S307). At the time, the received mail display column 63A, a browsing button 63B for browsing the received mail while it is displayed by the projector 16, and a “later browse” button 63C for browsing the received mail after the display thereof by the projector 16 is finished (that is, the mail is not browsed while it is displayed by the projector) are displayed overlapping on the display information display column 63 displayed at step S303 on the display screen 60 as shown in FIG. 11C. At the time, the information as to the mail reception such as the incoming mail display column, the browsing button, and the like is not displayed on the protection screen 70, and the state displayed at step S303 is held as shown in FIG. 11D.

When the received mail display column 63A is displayed on the display screen 60, the user selects the browsing button 63B or the “later browser button 63C through the operation keys 17. The main controller 20 determines whether or not it is instructed to browse the mail depending on whether the browsing button 63B is selected or the “later browse” button 63C is selected (S309).

When the browsing button 63A is selected and it is instructed to browse the mail (S309: Yes), the main controller 20 displays the mail information received at step S305 on the display screen 60 of the liquid crystal display 13 (S311). The display screen 60 at the time includes a mail information display column 63D on which the mail information is displayed, a return mail button 63E for sending a return mail while it is displayed by the projector 16, and a finish button 63F for finishing the display of the mail information as shown in FIG. 11E. Further, the information as to the mail reception such as the mail information display column, the return mail button, the finish button, and the like is not displayed on the projection screen 70 at the time, and the state displayed at step S303 is held as shown in FIG. 11F.

When the “later browse” button 63C is selected and it is not instructed to browse the mail (S309: No), the main controller 20 finishes the displays of the received mail display column 63A, the browsing button 63B, and the “later browse” button 63C on the display screen 60 of the liquid crystal display 13.

When the processing at step S311 is finished, when it is not instructed to browse the mail (S309: No) or when no mail is received (S305: No), the main controller 20 determines whether or not it is instructed to finish the display by the projector (S313). The user instructs to finish the display by the projector 16 by, for example, an input through the operation keys 17, and the like. When it is not instructed to finish the display by the projector 16 (S313: No), the main controller 20 returns to step S305 and determines whether or not a mail is received again.

When it is instructed to finish the display by the projector 16 (S313: Yes), the main controller 20 finishes the display on the display screen 60 of the liquid crystal display 13 and the display by the projector 16 on the projection screen 70 of the projector 16 (S315).

When the display is made by the projector in the mobile phone 1 as described above, the display information is displayed on both the display screen 60 of the liquid crystal display 13 and the projection screen 70 of the projector 16 as well as when a mail is received while the display is being made by the projector 16, it is displayed only on the display screen 60 of the liquid crystal display 13 that the mail is received. Further, when the user of the mobile phone 1 reads the received mail, the contents of the received mail are displayed only on the display screen 60 of the liquid crystal display 13.

According to the embodiment 3 of the electronic equipment (the mobile phone 1) of the present invention, when a mail is received while the display is being made by the projector 16, since it is displayed only on the display screen 60 of the liquid crystal display 13 that the mail is received or the contents of the received nail are displayed only thereon, it is possible to clearly display a lot of information at a time.

### EXAMPLE 4

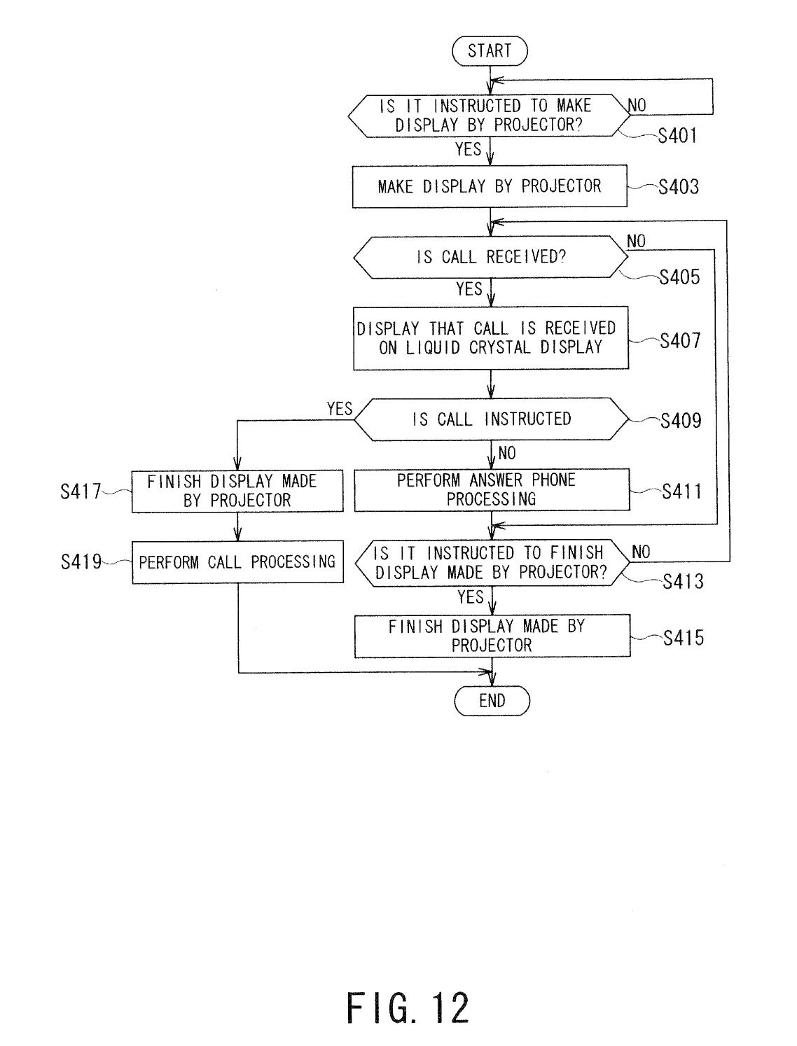

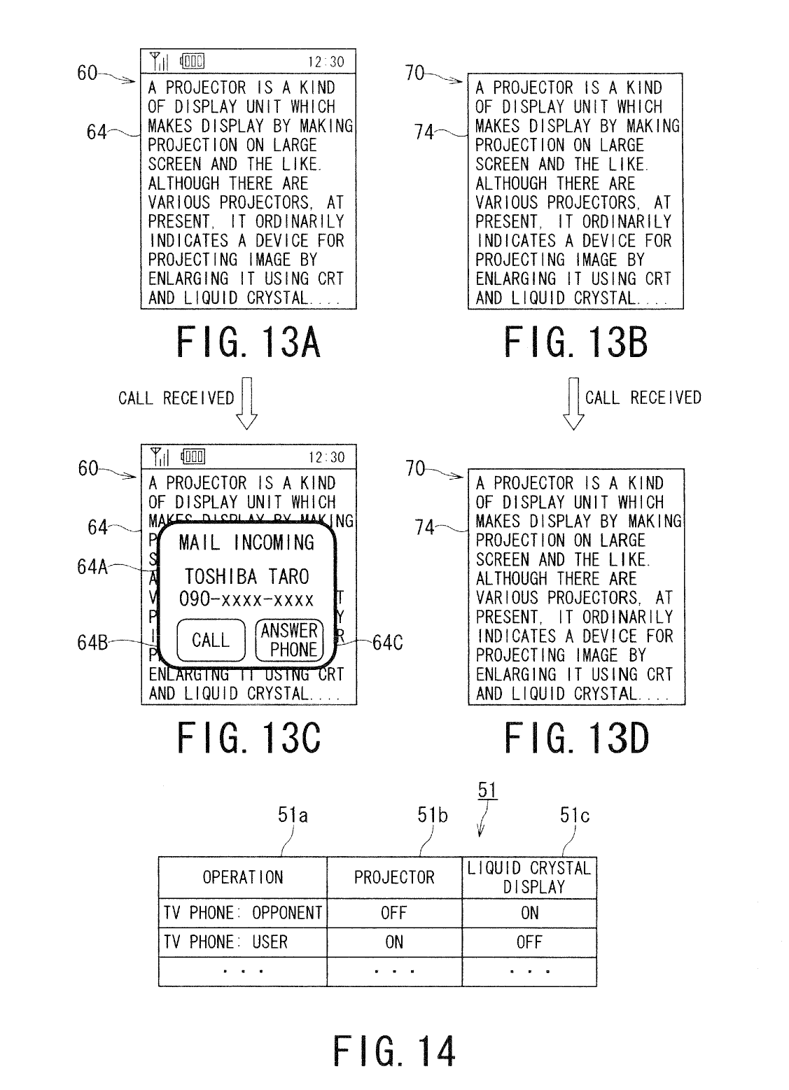

When the mobile phone 1 receives a incoming call while a plurality of persons observe the projection screen 70, there are contemplated circumstances in which although the user of the mobile phone 1 must confirm the information of the call, the user does not want the other persons who observe the projection screen 70 to read the information as to the incoming call likewise the embodiment 3. Incoming call processing preformed while a display is being made by the projector 16 will be explained as an embodiment 4 of the mobile phone 1 based on FIGS. 12 and 13.

A procedure when the mobile phone 1 performs the incoming call processing while the display is being made by the projector 16 will be explained based on a flowchart shown in FIG. 12. Note that it is assumed that, when the user instructs to make the display by the projector 16, the mobile phone 1 displays predetermined display information on the display screen 60 of the liquid crystal display 13 and the projection screen 70 of the projector 16.

First, the main controller 20 determines whether or not the user instructs to make the display by the projector 16 (S401). At the time, the user instructs to make the display by the projector 16 by an input through the operation keys 17, and the like. When it is not instructed to make the display by the projector 16 (S401: No), the main controller 20 waits as it is.

When it is instructed to make the display by the projector 16 (S401: Yes), the main controller 20 obtains the predetermined display information and displays the display information on the liquid crystal display 13 as the display screen 60 as well as displays it on the projection screen of the protector 16 as the protection screen 70 (S403). At the time, the display information stored in the storage unit 27 may be obtained or display information may be obtained through the antenna 31. The display screen 60 at the time includes a display information display column 64 on which the display information is displayed as shown in FIG. 13A. Further, the projection screen 70 at the time includes a display information display column 74 on which the display information is displayed likewise as shown in FIG. 13B.

The main controller 20 determines whether or not the mobile phone 1 receives a incoming call (S405). When the mobile phone 1 receives the incoming call (S405: Yes), the main controller 20 displays a incoming call display column 64A on the display screen 60 of the liquid crystal display 13 to display that the mobile phone 1 receives the incoming call. (S407). At the time, the incoming call display column 64A, which includes the phone number information of the opponent of the incoming call, a call button 643 for performing a call in response to the incoming call, and an answer phone button 64C for switching to an answer phone without responding to the incoming call (that is, no response is performed while the display is being made by the projector 16) are displayed overlapping on the display information display column 64 displayed at step S403 on the display screen 60 as shown in FIG. 13C. At the time, the projection screen 70 does not display the information as to the incoming call display column, the call button, the answer phone button, and the like, and the state displayed at step S403 is held.

When the incoming call display column 64A is displayed on the display screen 60, the user selects the call button 64B or the answer phone button 64C through the operation keys 17. The main controller 20 determines whether or not a call is instructed depending on whether the call button 64B is selected or the answer phone button 64C is selected (S409).

When the answer phone button 640 is selected and the call is not instructed (S409: No), the main controller 20 finishes the information as to the incoming mail such as the incoming main display column 64A, the call button 643, the answer phone button 64C, and the like on the display screen 60 of the liquid crystal display 13 as well as performs answer phone processing (S411).

When the processing at step S411 is finished or the mobile phone 1 receives no mail (S405: No), the main controller 20 determines whether or not it is instructed to finish the display by the projector 16 (S413). The user instructs to finish the display by the projector 16 by, for example, an input through the operation keys 17, and the like. When it is not instructed to finish the display by the projector 16 (S413: No), the main controller 20 returns to step S405 and determines whether or not the mobile phone 1 receives a mail again.

When it is instructed to finish the display by the projector 16 (S413: Yes), the main controller 20 finishes the display on the display screen 60 of the liquid crystal display 13 and the display by the projector 16 on the projection screen 70 of the projector 16 (S415).

When the call button 64B is selected and the call is instructed (S409: Yes), the main controller 20 finishes the display on the display screen 60 of the liquid crystal display 13 and the display by the projector 16 on the projection screen 70 of the projector 16 (S417). Then, the main controller 20 performs call processing in response to the incoming call at step S405 (S419).

When the display is made by the projector 16 in the mobile phone 1 as described above, the display information is displayed on both the display screen 60 of the liquid crystal display 13 and the projection screen 70 of the projector 16 as well as, when the mobile phone 1 receives a mail while the display is being made by the projector 16, the information showing that the mobile phone 1 receives the incoming call or the information as to the opponent from which the mobile phone 1 receives the incoming call is displayed only on the display screen 60 of the liquid crystal display 13. Further, when the user need not respond to the incoming call instantly, the display by the projector 16 can be continued by responding to the incoming call through the answer phone.

According to the embodiment 4 of the electronic equipment (the mobile phone 1) of the present invention, when the mobile phone 1 receives a mail while the display is being made by the projector 16, since the information showing that the mobile phone 1 receives the mail or the information as to the opponent from which the mobile phone receives the mail is displayed only on the display screen 60 of the liquid crystal display 13, it is possible to clearly display a lot of information at a time.

### EXAMPLE 5

The mobile phone 1 provides a TV phone function for transmitting an image (motion image) being picked up by a CCD camera 15 when a call is performed as well as receiving an image of an opponent side and displaying it on the liquid crystal display 13 or projecting it by the projector 16. When the TV phone function is used, since the image being received and the image being transmitted is separately displayed on the liquid crystal display 13 or by the projector 16, respectively, the image being received and the image being transmitted can be more clearly displayed in a larger size than the case in which both the images are displayed on the same screen (for example, on the display screen 60 of the liquid crystal display 13). With this arrangement, the recognition property of the user can be improved. This is particularly effective when the eyesight of the user is bad and when many persons make a call with each other through a TV phone.

TV phone processing performed by the main controller 20 will be explained as an example 5 of the mobile phone 1 based on FIGS. 14 to 17. In the example 5, when a call is made by the user using the TV phone function, the mobile phone 1 displays the image being received from the opponent and the image being transmitted from the user on the projection screen 70 of the projector 16 or on the display screen 60 of the liquid crystal display 13 based on the display destination information 51 showing a display destination when the user perform respective operations using the mobile phone 1.

The display destination information 51 is previously stored in the storage unit 27. As shown in FIG. 14, the display destination information 51 is the information in which operation information 51a showing the operation performed by the mobile phone 1, projector information 51 showing whether or not a display is to be made on the projection screen 70 of the projector 16, and liquid crystal display information 51c showing whether or not the display is to be made on the display screen 60 of the liquid crystal display 13 are caused to correspond to each other, respectively. When the display is to be made, the projector information 51b and the liquid crystal display information 51c are shown by, for example, “ON”, and when the display is not to be made, they are shown by “OFF”.

In, for example, the display destination information 51 shown in FIG. 14, the operation information 51a of “TV phone: opponent”, “the projector information 51b of OFF”, and the liquid crystal display information 51c of “ON” are caused to correspond to each other, respectively. Further, the operation information 51a of “TV phone: user”, the projector information 51b of “ON”, and the liquid crystal display information 51c of “OFF” are caused to correspond to each other, respectively. This means that when the mobile phone 1 performs TV phone processing, the image of the opponent side is displayed on the display screen 60 of the liquid crystal display 13 as well as the image of the user side is displayed on the projection screen 70 of the projector 16.

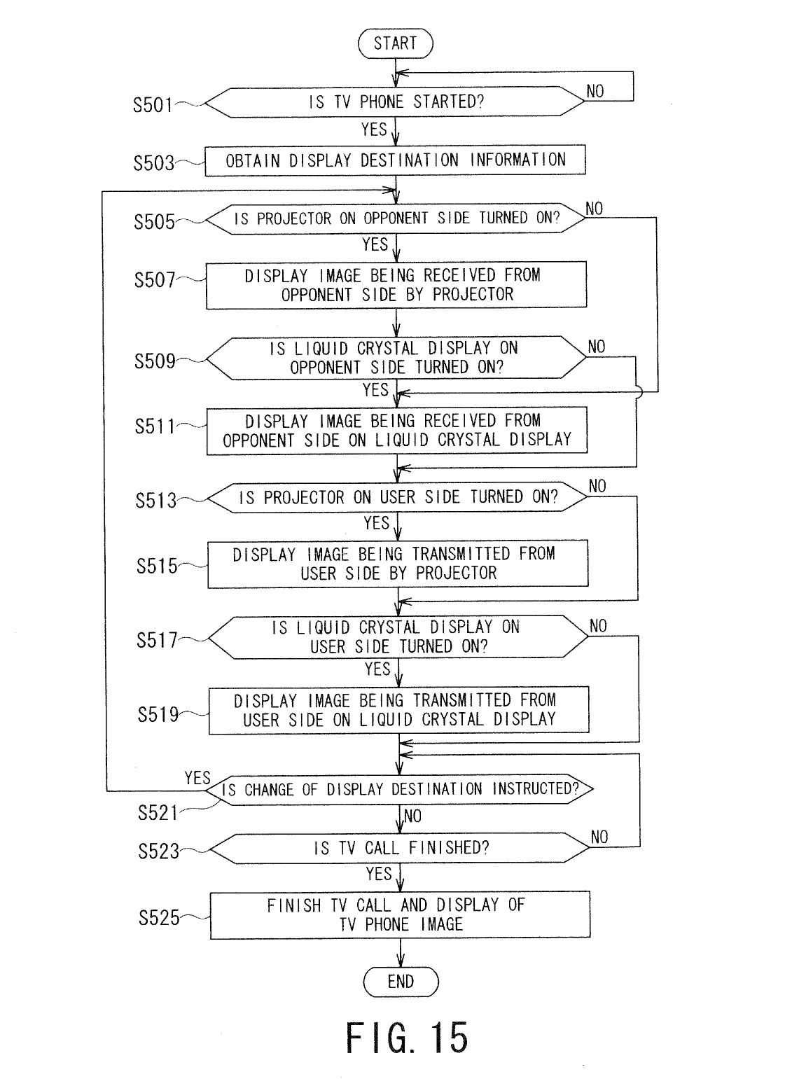

A procedure when the main controller 20 of the mobile phone 1 performs the TV phone processing based on the display destination information 51 will be explained based on a flowchart shown in FIG. 15.

First, the main controller 20 determines whether or not a call is started by the user using the TV phone function (S501). At the time, the call using the TV phone function is started in response of a incoming call using the TV phone function or by an input from the user through the operation keys 17, and the like. When the call using the TV phone function is not started (S501: No), the main controller 20 waits as it is. When the call using the TV phone function is started (S501: Yes), the main controller 20 obtains the display destination information 51 from the storage unit 27 (S503).

The main controller 20 determines whether or not the projector information 51b of an opponent is in the “ON” state when the TV phone function is operated based on the display destination information 51 obtained at step S503 (S505). When the projector information 51b of the opponent is in the “ON” state at the time the TV phone function is operated (S505: Yes), the main controller 20 displays the image being received from the opponent side on the projection screen 70 of the projector 16 (S507).

The main controller 20 determines whether or not the liquid crystal display information 51c of the opponent side is in the “ON” state when the TV phone function is operated based on the display destination information 51 obtained at step S503 (S509). When the liquid crystal display information 51c of the opponent side is in the “ON” state at the time the TV phone function is operated (S509: Yes), or when the projector information 51b of the opponent side is in the “OFF” state at the time the TV phone function is operated (S505: No), the main controller 20 displays image being received from the opponent side on the display screen 60 of the liquid crystal display 13 (S511).

The main controller 20 determines whether or not the projector information 51b on the user side is in the “ON” state when the TV phone function is operated based on the display destination information 51 obtained at step S503 (S513). When the projector information 51b on the user side is in the “ON” state at the time the TV phone function is operated (S513: Yes), the main controller 20 displays the image being transmitted therefrom on the projection screen 70 of the projector 16 (S515).

The main controller 20 determines whether or not the projector information 51b on the user side is in the “ON”state at the time the TV phone function is operated based on the display destination information 51 obtained at step S503 (S517). When the liquid crystal display information 51c on the user side is in the “ON” state at the time the TV phone function is operated, (S517: Yes), the main controller 20 displays the image being transmitted from the user side on the display screen 60 of the liquid crystal display 13 (S519).

When the main controller 20 has set the display destination at steps S505 to S519 based on the display destination information 51, it determines whether or not the user instructs to change the display destination (S521). At the time, it is instructed to change the display destination by an input from the user through the operation keys 17, and the like while the TV phone function is being operated. When it is instructed to change the display destination (S521: Yes), the main controller 20 performs the processing at step S505 to S519 again and sets the display destination a TV phone image based on the contents instructed by the user.

When it is not instructed to change the display destination (S521: No), the main controller 20 determines whether or not the TV phone function is finished (S523). At the time, the TV phone function is finished by, for example, the shut-off of the TV phone function performed by the opponent side or an input from the user through the operation keys 17, and the like. When the TV phone function is not finished (S523: No), the main controller 20 returns to step S521 and determines whether or not the user instructs to change the display destination.

When the TV phone function is finished (S523: Yes), the main controller 20 finishes the display of the TV phone image on the display screen 60 of the liquid crystal display 13 and or the projection screen 70 of the projector 16 (S525).

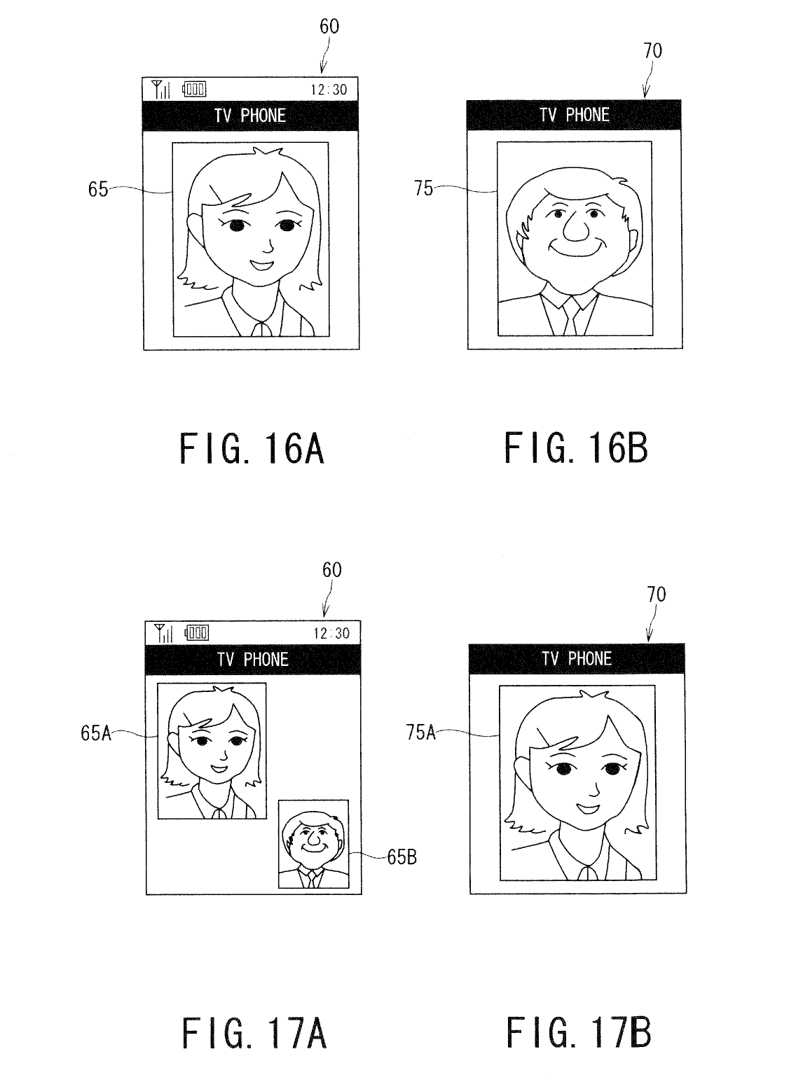

When a display is performed based on the display destination information 51 shown in FIG. 14, the image 65 being received from the opponent side is displayed on the display screen 60 of the liquid crystal display 13 as shown in FIG. 16A as well as the image 75 being transmitted from the user is displayed on the projection screen 70 of the projector 16 as shown in FIG. 16B.

Further, when, for example, the operation information 51a of “TV phone: opponent”, the projector information 51b of “ON”, and the liquid crystal display information 51c of “ON” are caused to correspond to each other, respectively and when the operation information 51a of “TV phone: user”, the projector information 51b of “OFF”, and the liquid crystal display information 51c of “ON” are caused to correspond to each other, respectively, an image 65A being received from the opponent side and an image 65B being transmitted from the user side are displayed on the display screen 60 of the liquid crystal display 13 as shown in FIG. 17A as well as an image 75 being received from the opponent side is displayed on the projection screen 70 of the projector 16 as shown in FIG. 17B.

When the call is performed using the TV phone function in the mobile phone 1 as described above, the image being received from the opponent side and the image being transmitted from the user side are displayed on the display screen 60 of the liquid crystal display 13 and on the projection screen 70 of the projector 16 based on the previously set display destination information 51. At the time, any or both of the image being received from the opponent side and the image being transmitted from the user side are displayed on the display screen 60 of the liquid crystal display 13 and on the projection screen 70 of the projector 16 according to the display destination information 51.

Further, when the user is instructed to switch the display destination while he or she makes a call using the TV phone function, the user switches “he display destination of the image being received from the opponent side and the image being transmitted from the user side based on the instructed contents.

According to the example 5 of the electronic equipment (the mobile phone 1) of the present invention, when the TV phone function is performed, since the image being received from opponent side and the image being transmitted from the user side are separately displayed on the display screen 60 of the liquid crystal display 13 or on the projection screen 70 of the projector 16, it is possible to clearly display a lot of information at a time.

Note that the example, in which the mobile phone projects the display contents using the projector 16 is explained. However, the present invention is not limited thereto, and it is also possible to connect external picture equipment such as a television, and the like to the mobile phone 1 and to output a display screen to the external picture equipment.

Further, when whether or not the various types of information, which is stored in the storage unit 27, is personal information is set, the information, which is set to be the personal information, may be filtered to shut off the projection thereof when the mobile phone 1 projects the various types of information using the projector 16. Specifically, an attribute, which shows that the various types of information stored in the storage unit 27 is the personal information, is previously attached to the information. As a result, when the various types of information is protected using the projector 16, the information, to which the attribute is not attached, is projected onto the projection screen 70 of the projector 16, whereas the information, to which the attribute is attached, is displayed on the display screen 60 of the liquid crystal display 13, thereby leakage of the personal information can be prevented.

Although the mobile phone 1 is explained as the explanation of the present invention, the present invention is not limited thereto, and the mobile phone 1 may be any arbitrary electronic equipment such as PHS (Personal Handy phone System), PDA (Personal Digital Assistants), and the like as long as it is provided with a display screen, for example, a liquid crystal display and the like and with a projector.

1. Electronic equipment comprising;
a first output unit configured to output display information onto a display screen;
a second output unit configured to output display information to a device to which the display information is output; and
an output control unit configured to cause, if predetermined display information is output using both the first output unit and the second output unit, the second output unit to output the portion of the predetermined display information to which it is previously set that it is output to the outside as well as causing the first output unit to output the portion of the predetermined display information from
which the portion output by the second output unit is excluded.

2. Electronic equipment comprising;
a first output unit configured to output display information onto a display screen;
a second output unit configured to output display information to a device to which the display information is output; and
an output control unit configured to cause, if first display information and second display information, which is different from the first display information, are output using both the first output unit and the second output unit, the first output unit to output the first display information as well as causing the second output unit to output the second display information.

3. The electronic equipment according to
claim 1, wherein the second output unit comprises a projection unit for projecting the display information.

4. The electronic equipment according to claim 1, comprising a storage unit configured to store telephone directory information including at least name information and phone number information, to which it is set that they are not output to the outside, and image information to which it is set that it is output to the outside,
wherein the output control unit causes the second output unit to output the image information as well as causes the first output unit to output the name information and the phone number information.

5. The electronic equipment according to claim 4, wherein the output control unit causes the first output unit to output the name information and the phone number information so that they are displayed in enlargement.

6. The electronic equipment according to claim 1 comprising an input reception unit configured to receive the input of a character string while the first output unit and the second output unit outputs the display information, wherein if the input reception unit receives the input of the character string, the output control unit causes the first output unit to output the information as to the input.

7. The electronic equipment according to claim 1 comprising a reception unit configured to receive a mail,
wherein if the reception unit receives the mail at the time the first output unit and the second output unit output the display information, the output control unit causes the first output unit to output the information as to the received mail.

8. The electronic equipment according to claim 1 comprising a reception unit configured to receive a mail,
wherein if the reception unit receives the mail at the time the first output unit and the second output unit output the display information, the output control unit sets the information as to the received mail to the portion from which the portion output by the second output unit is excluded.

9. The electronic equipment according to claim 2 comprising a reception unit configured to receive a mail,
wherein if the reception unit receives the mail at the time the first output unit and the second output unit output the display information, the output control unit sets the information as to the received mail to the first display information.

10. The electronic equipment according to claim 1 comprising an incoming call reception unit configured to receive an incoming call,
wherein if the incoming call reception unit receives the incoming call at the time the first output unit and the second output unit output the display information, the output control unit causes the first output unit to output the information as to the incoming call.

11. The electronic equipment according to claim 1, comprising an incoming call reception unit configured to receive an incoming call,
wherein if the incoming call reception unit receives an incoming call at the time the first output unit and the second output unit output the display information, the output control unit sets the information as to the incoming call to the portion from which the portion output by the second output unit portion is excluded.

12. The electronic equipment according to claim 2, comprising an incoming call reception, unit configured to receive an incoming call,
wherein if the incoming call reception unit receives the incoming call at the time the first output unit and the second output unit output the display information, the output control unit sets the information as to the incoming call to the first display information.

13. The electronic equipment according to claim 2, wherein the output control unit causes the first output unit to output the image being received from an opponent side and causes the second output unit to output the image being transmitted from a user side if a TV phone function is performed.

14. The electronic equipment according to claim 2, wherein the output control unit causes the second output unit to output the image being received from an opponent side and causes the first output unit to output the image being transmitted from a user side if a TV phone function is performed.

15. The electronic equipment according to claim 1 comprising a storage unit configured to store various types of information to which an attribute showing whether or not the various types of information is personal information,
wherein the output control unit causes the first output unit to output the information to which the attribute showing that the information is the personal information is attached as well as causes the second output unit to output the information to which the attribute showing that the information is the personal information is not attached.

16. The electronic equipment according to claim 2, wherein the second output unit comprises a projection unit for projecting the display information.

17. The electronic equipment according to claim 2, comprising a storage unit configured to store telephone directory information including at least name information and phone number information, to which it is set that they are not output to the outside, and image information to which it is set that it is output to the outside,
wherein the output control unit causes the second output unit to output the image information as well as causes the first output unit to output the name information and the phone number information.

18. The electronic equipment according to claim 17, wherein the output control unit causes the first output unit to output the name information and the phone number information so that they are displayed in enlargement.

19. The electronic equipment according to claim 2, comprising an input reception unit configured to receive the input of a character string while the first output unit and the second output unit outputs the display information,
wherein if the input reception unit receives the input of the character string, the output control unit causes the first output unit to output the information as to the input.

20. The electronic equipment according to claim 2 comprising a reception unit configured to receive a mail,
wherein if the reception unit receives the mail at the time the first output unit and the second output unit output the display information, the output control unit causes the first output unit to output the information as to the received mail.

21. The electronic equipment according to claim 2 comprising an incoming call reception unit configured to receive an incoming call,
wherein if the incoming call reception unit receives the incoming call at the time the first output unit and the second output unit output the display information, the output control unit causes the first output unit to output the information as to the incoming call.

22. The electronic equipment according to claim 2 comprising a storage unit configured to store various types of information to which an attribute showing whether or not the various types of information is personal information,
wherein the output control unit causes the first output unit to output the information to which the attribute showing that the information is the personal information is attached as well as causes the second output unit to output the information to which the attribute showing that the information is the personal information is not attached.
